(19) United States
(12) Patent Application Publication
(10) Pub. No.: US 2003/0184769 A1
(43) Pub. Date: Oct. 2, 2003

(54) Patterned implant metrology

(76) Inventors: Erik Cho Houge, Orlando, FL (US); John Martin McIntosh, Orlando, FL (US); Cynthia C. Lee, Orlando, FL (US)

Correspondence Address: BEUSSE, BROWNLEE, BOWDOIN & WOLTER, P. A., 390 NORTH ORANGE AVENUE, SUITE 2500, ORLANDO, FL, 32801, US

(21) Appl. No.: 10/108,096

(22) Filed: Mar. 27, 2002

(51) Int. Cl. G01B 11/04

(52) U.S. Cl. 356/636

(57) ABSTRACT

A method (40) for nondestructively characterizing a doped region (24) of a semiconductor wafer (22) in order to determine the acceptability of a pattern transfer process. Of particular interest is the determination of the lateral profile of the implanted structure. An incident beam (28) of radiation is directed upon the wafer surface (26) and the properties of the resulting refracted beam (30) are measured as a function of wavelength. The spectrally-resolved diffraction characteristics of the refracted beam are directly related to the shape and scale characteristics of the doped region. A library (44) of calculated diffraction spectra is established by modeling a full range of expected variations in the doped region structures. The spectra resulting from the inspection of an actual doped region (46) is compared against the library to identify a best fit (48) in order to characterize the actual implant (50). The results of the comparison may be used as an input for upstream and/or downstream process control (52).

### BACKGROUND OF THE INVENTION

The present invention relates generally to the field of metrology, and more particularly to the nondestructive measurement of the dimensions of subsurface features of a semiconductor wafer.

Quality control for the production of microelectronic devices, such as integrated circuits formed on semiconductor substrate wafers, often depends upon the accurate measurement of the dimensions of various features formed on the substrate surface. There are many types of both optical and electron-based metrology tools available for this analysis, including scanning electron microscopes, focused ion beam microscopes, focused x-ray microscopes and focused optical microscopes including near-field scanning optical microscopes. The critical dimension scanning electron microscope (CD-SEM) utilizes algorithms based upon the intensity of line scan profiles of images to extract the apparent width of surface features. Another technique for nondestructively examining microelectronics devices is scanning probe microscopy (SPM) wherein a probe tip is used to study the surface topography or properties of the surface of a substrate. SPM tools include the atomic force microscope (AFM) and the stylus nanoprofilometer (SNP). Furthermore, scatterometers have been proposed for obtaining high speed two dimensional topographic information. All of these techniques are used to examine features disposed on the surface of a semiconductor device.

U.S. Pat. No. 5,293,216 describes a sensor device for semiconductor manufacturing which operates on the principle of scatterometry. A coherent beam of laser energy is directed toward a semiconductor wafer surface. Coherent and scattered portions of the beam that are reflected by and transmitted through the wafer are measured and analyzed. This device is used to determine the surface roughness and spectral emissivity values of the wafer. The surface roughness measurement is further correlated to a film thickness value.

Other United States patents describe other applications of scatterometer systems for measuring surface features on a semiconductor wafer. U.S. Pat. No. 5,923,423 describes a heterodyne scatterometer for detecting and analyzing wafer surface defects. U.S. Pat. No. 5,703,692 describes an optical scatterometer system that provides illumination of a sample at various angles of incidence without the need for rotating the sample. U.S. Pat. No. 6,154,280 describes a system for measuring surface roughness using two separate beams of electromagnetic radiation. Each of the above-described prior art patents are hereby incorporated by reference herein.

Certain semiconductor manufacturing processes involve the implantation of an impurity dopant species, such as boron, phosphorus, and arsenic into a germanium or a silicon containing layer above or below the surface of a substrate wafer to form a conducting or semi-conducting region. Such an implanted region may be used as a gate conductor or a source/drain region of a MOSFET device, for example. The dopant may be introduced using a known ion implantation process, illustrated in FIG. 1A, where a surface 20 of semiconductor wafer 10 is selectively exposed to bombardment by high energy dopant ions 12 though a pattern of openings 14 formed in a developed layer of photoresist material 16. The dopant ions 12 penetrate the wafer 10 to form a periodic pattern of implanted modules 18 below the wafer surface 20, as illustrated in FIG. 1B. The periodic structure of implanted modules 18 remains after the layer of photoresist 16 has been removed, as illustrated in FIG. 1C.

The distribution of the dopant forming the implanted modules 18 is important to the performance of the semiconductor device. The concentration of dopant as a function of the width and depth dimensions (X,Y) and the shape of the implanted module 18 are parameters of interest. Prior art systems are known for determining the depth (Y) of the implanted dopant, but there has not been a nondestructive system available for determining the width (X) or shape of the implanted module 18.

Implant depth profiling is currently accomplished by using a secondary ion mass spectrometry (SIMS) technique. The SIMS process involves directing a destructive ion beam toward the semiconductor wafer surface to erode the substrate material in an area approximately 100 microns square. A mass spectrometer is then used to analyze the material being eroded from the surface to determine the species present. This analysis technique is destructive to the specimen being evaluated, and it provides implant depth information only. The size of the eroded area far exceeds the width dimension (X) normally associated with implanted dopant structures, and no information related to the width or shape of the implanted module 18 can be obtained.

### BRIEF SUMMARY OF THE INVENTION

There is a particular need for a nondestructive examination technique for measuring the width and depth dimensions (X,Y) and shape of a patterned implanted material below the surface of a semiconductor substrate.

A method of examining a doped region of a semiconductor wafer includes illuminating a surface of a semiconductor wafer proximate a doped region of the wafer with an incident beam of electromagnetic energy; detecting the electromagnetic energy diffracted from the semiconductor wafer to obtain spectrally-resolved diffraction characteristics; and analyzing the diffraction characteristics to characterize the doped region. The diffraction characteristics may be analyzed to determine a lateral dimension profile of the doped region. The method may further include: establishing a library of diffraction characteristics for a plurality of modeled doped region structures; and comparing the diffraction characteristics of the electromagnetic energy diffracted from the semiconductor wafer to the diffraction characteristics of the library to identify a best fit to one of the plurality of modeled doped region structures. A process may be controlled in response to the results of the step of analyzing or in response to the lateral dimension profile. The method may include: illuminating the surface of the semiconductor wafer with multi-frequency polarized electromagnetic energy; measuring the relative phase change and the relative amplitude change of the electromagnetic energy diffracted from the semiconductor wafer as a function of wavelength; and comparing the spectra of measured relative phase and amplitude changes to a calculated spectra of phase and amplitude changes for a design-basis doped region to determine the fidelity of a pattern transfer process.

A method of confirming the fidelity of a pattern transfer process for a semiconductor wafer is disclosed herein as including: using a pattern transfer process to implant a periodic pattern of doped regions below a surface of a semiconductor wafer; directing a beam of electromagnetic energy onto the surface of the semiconductor wafer; obtaining spectrally-resolved diffraction characteristics of the electromagnetic energy refracted from the semiconductor wafer; and using the spectrally-resolved diffraction characteristics to compare the pattern of doped regions against a design-basis pattern of doped regions. The method may further include controlling the pattern transfer process in response to the spectrally-resolved diffraction characteristics.

An apparatus for inspecting a semiconductor wafer includes an instrument for measuring spectrally-resolved diffraction characteristics associated with a subsurface region; a library of spectrally-resolved diffraction characteristics calculated for a plurality of subsurface regions; and a comparator for selecting one of the spectrally-resolved diffraction characteristics from the library as a best fit to spectrally-resolved diffraction characteristics measured by the instrument. The apparatus may further include a process control device responsive to an output of the comparator.

### BRIEF DESCRIPTION OF THE DRAWINGS

The features and advantages of the present invention will become apparent from the following detailed description of the invention when read with the accompanying drawings in which:

FIGS. 1A, 1B and 1C illustrates sequential steps in a prior art ion implantation process.

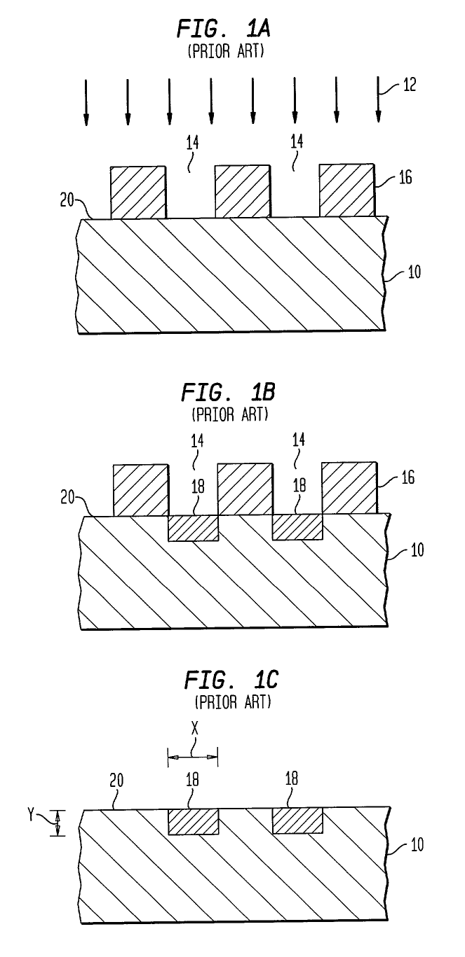

FIG. 2 is a partial cross-sectional view of a semiconductor wafer having subsurface doped regions that are being nondestructively examined to determine their critical dimension profile.

FIGS. 3A, 3B and 3C illustrate how the diffraction characteristics of a refracted beam are spectrally resolved as a function of wavelength.

FIG. 4 illustrates a system and method for nondestructive examination and control of a semiconductor wafer implanted dopant region.

### DETAILED DESCRIPTION OF THE INVENTION

It is now recognized that the principles of ellipsometry may be used for nondestructive examination of periodic subsurface features such as doped regions of a semiconductor substrate. For example, critical dimension information may be acquired to confirm the fidelity of a pattern transfer process involving the implantation of a dopant through a patterned photoresist layer. Such information may be used for making an accept/reject decision or to control process variables for centering dose and distribution of a dopant. Confirmation of the fidelity of a pattern transfer process may include dimensional verification, as well as threshold determinations as to whether dopant has been implanted, and whether the correct species have been implanted.

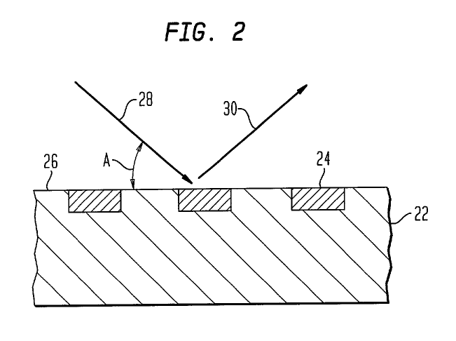

An exemplary embodiment of the invention is now described beginning with the view of FIG. 2. A work piece such as semiconductor wafer 22 has a feature such as a periodic pattern of implanted dopant regions 24 formed below a top surface 26. The implanted dopant regions 24 may represent a test pattern. The dimensions and concentration profile of the implanted dopant regions 24 are characterized and compared to possible values to assess the pattern transfer process performed on the wafer 22, as described more fully below.

Incident radiation such as an incident beam of polarized electromagnetic energy 28 is directed toward the substrate top surface 26 at an angle of incidence A. The incident beam 28 may be coherent laser energy or non-coherent energy of single or multiple wavelengths. The energy of the incident beam 28 or incident radiation interacts with the wafer 22 to produce a diffracted beam of electromagnetic energy 30. The diffracted beam or diffracted radiation as referenced herein is understood to include all electromagnetic energy resulting from the variety of interactions between the incident beam and an object, including reflection, bending and absorption components. At each film interface, energy may be both transmitted and reflected according to the angle of incidence and the index of refraction. As the energy passes through the material of the wafer 22 it may be partially absorbed and its direction of travel changed. The resulting diffracted beam 30 is a function of the properties of the incident beam 28 as well as the properties of the wafer 22, including the pattern and material of implanted dopant regions 24. A direct relationship exists between the structure of the wafer 22 and the polarization rotation (cosine Δ) and amplitude (tangent ψ) of the refracted beam 30.

Ellipsometry is a known optical technique for determining properties of surfaces and thin films. When linearly polarized light of a known orientation is reflected at an oblique angle it is elliptically polarized. The shape and orientation of the ellipse will depend upon the angle of incidence, the direction of the polarization of the incident light, and the reflection properties of the surface. By measuring the polarization of the reflected light, it is possible to calculate the relative phase change Δ and the relative amplitude change ψ introduced by the surface and the depth of the material that the light has penetrated. In the past these two variables have been used to determine the index of refraction and the thickness of a film.

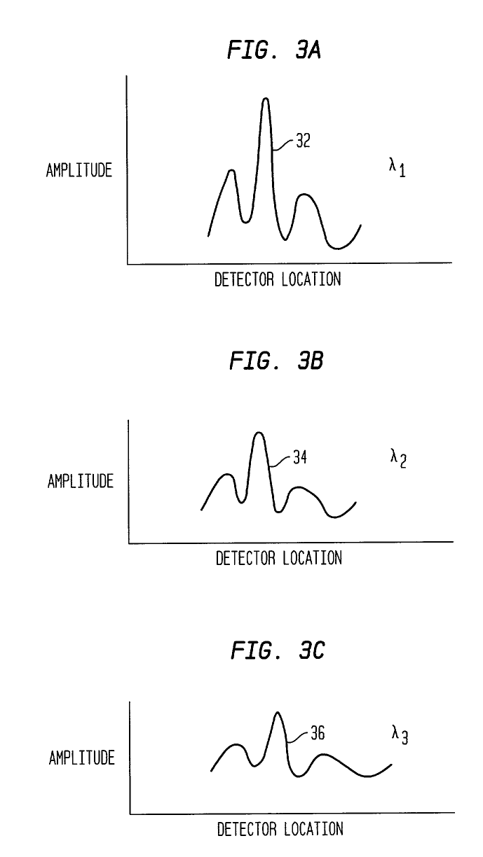

The principles of ellipsometry are now applied to the wafer 22 of FIG. 2 to further determine characteristics of a structure, e.g. lateral dimension information. Generally, it is also desirable to determine the concentration of dopant as a function of depth and width (X,Y). Accordingly, the incident beam 28 may be varied in frequency to vary the relative phase change Δ and the relative amplitude change ψ of the diffracted beam as a function of wavelength. FIGS. 3A-3C illustrate this effect for a hypothetical wafer 22 having a periodic pattern of implanted regions 24. Each of the curves 32, 34, 36 depicts the amplitude of the diffracted beam 30 as the position of a detector is moved along a line parallel to wafer surface 26, with each curve 32, 34, 36 representing a particular frequency of incident beam 28. Note that the amplitude of the refracted beam 30 and the relative location of the amplitude peaks (i.e. the phase) both change as a function of frequency. A plurality of incident beam frequencies in the range of 180 nanometers to 1 micron may be used to generate such amplitude and phase information. Depending upon the type of ellipsometer being used, this phenomenon may be measured in a variety of manners, such as using multiple single-frequency energy sources or one multi-frequency energy source, by moving the energy source or the detector or the wafer 22, or with no physical motion by sweeping the frequency of the inspection apparatus.

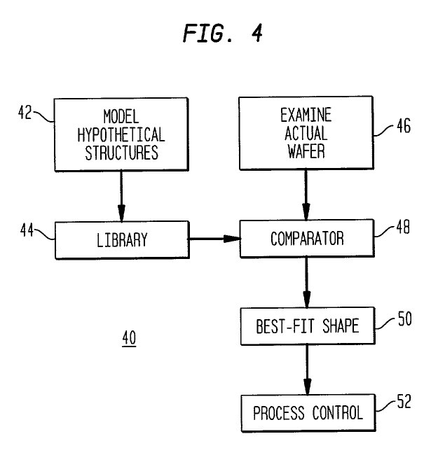

Software programs are commercially available for modeling the diffraction properties of a sample. One such program is available from KLA-Tencore Corporation of San Jose, Calif. Such programs may be used in a process 40 for examining a structure implanted below a surface of a semiconductor wafer, as illustrated in FIG. 4. The modeling program is used at step 42 to predict the properties of a diffracted beam 30 for a design-basis implanted dopant region 24 and for any number of hypothetical implanted dopant regions that are expected deviations from the design-basis structure. All possible variations of region width and shape may be modeled and the spectra of results stored in a computerized library 44. Such a library 44 may include as many as 100,000 or even a million or more such results, for example. A test feature such as a pattern of implanted doped regions 24 of an actual wafer is then examined 46 using instrumentation to provide a characterization of the test feature in terms of spectral characteristics of diffracted radiation from the actual wafer. The spectral characteristics are then processed to determine a structural characterization of the test feature. Circuitry for processing the spectral characteristics to determine the structural characterization may include, for example, a comparator 48. Comparator 48 is used to compare the modeled results stored in the library 44 to the spectral characteristics determined at step 46. Comparator 48 may be a computerized data processing device implementing a best-fit analysis or other known numerical processing technique. The best-fitting of the modeled spectra is selected at step 50 as being representative of the actual shape of the doped region, and may further be used for controlling a downstream and/or upstream process control device 52. If the pattern transfer process is not properly controlled or if the wrong net dopant was formed, no modeled spectra will fit the actual shape. The acceptability of the pattern transfer process used to create the test structure is demonstrated if the actual implanted region shape is within a defined tolerance range of the design-basis structure. Process variables may be changed for a pattern transfer process device 52 to return an out-of-tolerance process to design-basis conditions.

While the preferred embodiments of the present invention have been shown and described herein, it will be obvious that such embodiments are provided by way of example only. Numerous variations, changes and substitutions will occur to those of skill in the art without departing from the invention herein. For example, the application of the forgoing concepts need not be limited to ellipsometry, and they need not be limited to a comparative function. Accordingly, it is intended that the invention be limited only by the spirit and scope of the appended claims.

We claim as our invention:

1. A method for use in manufacture, the method comprising:
illuminating with radiation a work piece having a feature;
obtaining spectrally-resolved characteristics of the radiation diffracted from the work piece; and
analyzing the characteristics to characterize the feature.

2. The method of claim 1, further comprising analyzing the characteristics to determine a lateral dimension profile of the feature.

3. The method of claim 1, further comprising:
establishing a library of spectrally-resolved characteristics for a plurality of modeled work piece features; and
determining a best fit between the characteristics of the radiation diffracted from the work piece and the characteristics from the library.

4. The method of claim 1, further comprising controlling a process in response to the results of the step of analyzing.

5. The method of claim 2, further comprising controlling a process in response to the lateral dimension profile.

6. The method of claim 1, further comprising:
illuminating the surface of a semiconductor wafer having a doped region with multi-frequency polarized electromagnetic energy;
obtaining the spectrally-resolved characteristics by measuring the phase change and amplitude change of the electromagnetic energy diffracted from the semiconductor wafer as a function of wavelength; and
comparing the obtained spectrally-resolved characteristics to a calculated spectra of phase and amplitude changes for a design-basis doped region.

7. The method of claim 1, wherein the work piece comprises a semiconductor wafer, the method further comprising:
using a pattern transfer process to form the feature as a periodic pattern of doped regions;
directing radiation onto the surface of the semiconductor wafer;
obtaining spectrally-resolved diffraction characteristics of the radiation refracted from the semiconductor wafer; and
using the spectrally-resolved diffraction characteristics to evaluate the pattern transfer process.

8. The method of claim 7, further comprising controlling the pattern transfer process in response to the spectrally-resolved diffraction characteristics.

9. A system for use in manufacture, the system comprising:
instrumentation for providing a characterization of a feature of a work piece in terms of spectral characteristics of diffracted radiation from the work piece; and
circuitry for determining a structural characterization of the feature based upon the spectral characterization.

10. The system of claim 9, wherein the circuitry comprises a storage location for data and a sub-circuitry configured to determine the structural characterization based on a comparison between data in the storage location and the characterization of the feature.

11. The system of claim 9, further comprising a process control element responsive to the structural characterization.

12. The system of claim 9, further comprising:
an ellipsometer for determining spectrally-resolved diffraction characteristics of radiation refracted from a semiconductor wafer having a doped region;
a library storing spectrally-resolved diffraction characteristics calculated for a plurality of semiconductor wafer doped regions; and
a comparator for selecting a best fit between the spectrally-resolved diffraction characteristics determined with the ellipsometer and one of the spectrally-resolved diffraction characteristics stored in the library.

13. The apparatus of claim 12, further comprising a process control device responsive to an output of the comparator.

14. An apparatus comprising:
instrumentation having an output responsive to the spectral characteristics of radiation diffracted from a work piece; and
a process control element responsive to the instrumentation output.

15. The apparatus of claim 14, further comprising:
an ellipsometer for determining spectrally-resolved diffraction characteristics of radiation refracted from a semiconductor wafer having a doped region;
a library storing spectrally-resolved diffraction characteristics calculated for a plurality of semiconductor wafer doped regions; and
a comparator for selecting a best fit between the spectrally-resolved diffraction characteristics determined with the ellipsometer and one of the spectrally-resolved diffraction characteristics stored in the library.

16. The apparatus of claim 14, wherein the work piece is a semiconductor wafer having a doped region, and wherein the output is responsive to a lateral dimension profile of the doped region.
